(19) United States
(12) Patent Application Publication
(10) Pub. No.: US 2026/0336834 A1
(43) Pub. Date: Oct. 29, 2026

(54) Method and Apparatus for the Stabilization of a Satellite Formation

(71) Applicant: Politecnico Di Torino, Torino (TO) (IT)

(72) Inventors: Marcello Romano, Torino (IT); Stefano Aliberti, Torino (IT); Riccardo Apa, Torino (IT); Catello Leonardo Matonti, Torino (IT)

(21) Appl. No.: 19/491,060

(22) PCT Filed: Jun. 3, 2024
(86) PCT No.: PCT/IB2024/055394

§ 371 Date: Dec. 8, 2025

(30) Foreign Application Priority Data
Jun. 9, 2023 (IT) 102023000011844

(51) Int. Cl. B64G 1/40; B64G 1/10; B64G 1/24; B64G 1/64

(52) U.S. Cl. CPC B64G 1/411; B64G 1/1085; B64G 1/242; B64G 1/648

(57) ABSTRACT

The invention relates to a method for stabilization of the orbital motion set-up of a group of satellites bound to a tether. To such end, the tension (T) of the tether that connects two or more satellites is controlled in order to keep them in the desired flight formation. This effect is obtained by perturbing a satellite to generate a tension component (T) in the tether, which results in a recoil force that brings the system back into a condition of equilibrium. According to a preferred embodiment, the tension (T) of the tether is obtained by adjusting the disposition of one or more aerodynamic surfaces provided on the satellites at the ends of the tether.

### BACKGROUND OF THE DISCLOSURE

### 1. The Field of the Disclosure

The invention relates, in general, to a method for controlling the orbital motion set-up of a group of satellites.

### 2. The Relevant Technology

As is known, the orbital motion of satellites in formation flight involves several difficulties associated with position keeping; in fact, the different distances between the satellites and the Earth (or another planet), around which they orbit, result in perturbations tending to modify the flight set-up and configuration of the satellite formation, thus requiring the use of satellite flight control and correction systems.

Set-up corrections are made by controlling a number of stabilization variables, which depend on factors such as formation type (e.g., independent or interconnected satellites), orbital speed, fixed or adjustable orientation of the satellites about their axis, mass, propulsion, and the like.

Stabilization control presents a number of problems connected to the complexity of the satellites' architecture (sensors, actuation, costs) and to co-ordination among the individual satellites of the formation (determination and control of relative rototranslational dynamics).

The existing interconnected (“tethered”) satellite systems can partly solve such problems by means of a mechanical connection of the satellites.

In electrodynamic tethered systems, a main satellite has an electrically conductive tether, which may be several kilometers long, to which a load or towed satellite is connected.

The effect of the electrodynamic currents induced in the tether by its motion through the Earth's magnetic field can be exploited to manoeuver the cable and the load satellite even when they are not arranged radially relative to the main satellite and its orbit.

One example of this state of the art can be found in patent publication U.S. Pat. No. 3,582,016.

Basically, in addition to performing the mechanical function of physically connecting the satellites to each other, the tether of such orbital systems is also an electric conductor through which electrodynamic current can circulate.

In order to obtain sufficient forces, however, it is necessary to use very long tethers, which cause technological difficulties in implementing and reproducing a system for formation flight mission scenarios.

Furthermore, as concerns the state of the art of tethered satellites orbiting in flight formation, they are generally used in a radial configuration because they will naturally stay in position by exploiting the effects of the gravitational gradient.

However, such effects can only be utilized in the above-described configuration, thus limiting the possible applications of the system and excluding, therefore, any applications wherein the satellites are aligned along directions perpendicular to the radial direction (indicated as ô3 and ô2 in the reference system shown in FIG. 2).

### SUMMARY OF THE DISCLOSURE

In consideration of the current state of the art, the need is therefore felt for alternative strategies for stabilizing tethered satellites in orbital flight formation.

It can therefore be stated that the technical problem at the basis of the invention is to fulfill this need.

In other words, the invention provides a method for stabilizing the flight configuration of a group of orbiting satellites, which allows the use of different types of set-up such as, for example, transversal to the radial direction of the orbit (indicated as 63 in the reference system shown in FIG. 2).

It is another object of the invention to reduce the consumption of fuel for maintaining the flight set-up of the group of satellites.

It is a further object of the invention to reduce the complexity of the individual satellite and of the group of satellites, resulting in lower engineering and production costs.

The idea that solves the above-mentioned technical problem is to exploit the tension of the tether that connects two or more satellites in order to keep them in the desired orbital flight formation.

High-fidelity simulations carried out by the present inventors on an orbiting space system of tethered satellites have shown that the relative positions of the satellites can be stabilized by introducing a control force that stretches the tether.

In principle, it can be imagined that, by perturbing a body connected to a taut line, a tension component will be generated in the line which will produce an elastic force bringing the body back into the position of equilibrium.

By keeping under tension the line that mechanically connects the satellites in the flight formation, this effect can be exploited to compensate for external perturbations and maintain the desired flight set-up.

In accordance with a preferred embodiment of the satellite formation, flight set-up control is attained by adjusting the disposition of one or more aerodynamic surfaces provided on the satellites. To this end, according to a further preferred embodiment of the invention, the flight of the group of satellites occurs in a low Earth orbit, so as to allow the aerodynamic surfaces to interact with the atmosphere layers that are farthest from the Earth.

These and other features of the invention are more specifically set out in the appended claims.

### BRIEF DESCRIPTION OF THE DRAWINGS

Such features, as well as the structure and operation of the invention, will become more apparent in light of the following description of an embodiment thereof as shown in the drawings annexed hereto by way of non-limiting example, wherein:

FIG. 1 schematically shows the forces involved in satellite stabilization in accordance with the invention;

FIG. 2 schematically shows a flight formation of a pair of satellites according to the invention;

FIG. 3 shows a detail of one of the satellites of FIG. 2;

FIG. 4 schematically shows a flight formation of satellites according to the invention, in flight in a terrestrial orbit;

FIG. 5 shows a schematic view of the satellite formation of FIG. 4;

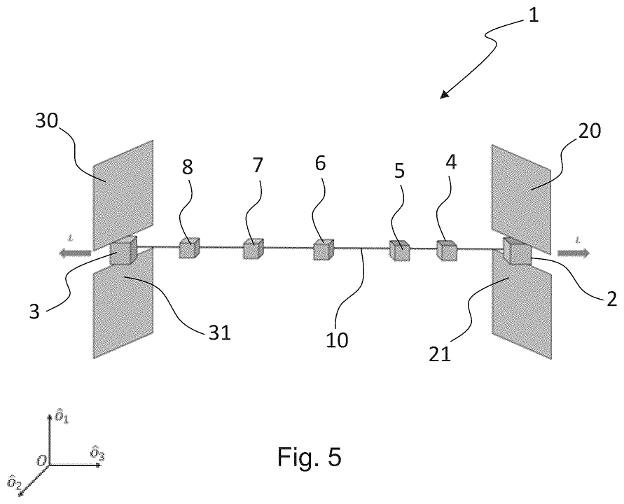

FIG. 6 shows a view of the satellite formation of FIG. 4 from a different angle, highlighting the baseline used for remote sensing applications;

FIG. 7 schematically shows a variant of the method for stabilization of the satellite formation of FIG. 4;

FIG. 8 schematically shows a further variant of the method for stabilization of a satellite formation according to the invention.

### DETAILED DESCRIPTION OF THE PREFERRED EMBODIMENTS

With reference to the above-listed figures, reference numeral 1 designates as a whole a formation or group of satellites according to the invention.

The formation 1 may comprise at least two, but preferably three, four, . . . n, satellites 2, 3, 4, 5, 6, . . . n, mutually connected by a tether 10.

The latter is preferably a flexible cable, suitable for acting as a tie member between two satellites 2, 3 connected to its ends; the tether 2 has mechanical properties, such as tensile strength, torsional strength, elasticity, flexibility, and the like, which are appropriate for the operating conditions that will be detailed below.

The tether 10 is, preferably, of the non-electrodynamic type, i.e., it is unsuitable for generating electromotive force through its orbiting motion in the Earth's magnetic field.

Therefore, it can be made of electrically insulating material, such as, for example, a synthetic material resistant to the solar radiation of the orbit, or anyway coated or protected (e.g., impregnated) with radiation-resistant material.

Some possible materials for the tether 10 can be selected from the group including polyethylene, polypropylene, polystyrene, polycarbonate, polyester, polyvinyl chloride (PVC), aramid fibers, and the like.

The tether 10 may be configured either as a stranded rope or as a sheathed bundle of strings, even though any other solutions suitable for this purpose may be used as well.

The tether 10, or at least part thereof, may also be made out of metal wires, in which case it may be of the electrodynamic type; however, this is not relevant for the invention, which can also be implemented with electrically insulating (or insulated) tethers.

The satellites 2, 3, 4, 5, 6, . . . n may have any configuration or mass, provided that they are suitable for orbital motion around the Earth or another planet. Therefore, they may be telecommunications satellites performing antenna functions, or satellites for interplanetary observations, scientific surveys, material transportation, etc.

Regardless of this, the satellites 2, 3, 4, 5, 6, . . . n are connected along the tether 10, and at least those satellites 2, 3 which are located at the end of the tether 10 are equipped with panels 20, 21 and, respectively, 30, 31, which can be oriented about at least one generic axis X of the corresponding satellite 2, 3.

In the example illustrated herein, the panels 20, 21 and 30, 31 are flat surfaces having a constant geometry or, optionally, deployable in orbit, with a quadrilateral shape and extending on opposite sides of the satellite. They can be rotated and oriented about the generic axes X to change the angle of incidence α relative to the orbital movement velocity ν.

For this purpose, the satellites 2, 3 are provided with electric motors (not shown) for moving the panels 20, 21 and 30, 31.

Alternatively, the aerodynamic surfaces (20,21,30,31) are integral with the satellites, and the angle of incidence α relative to the orbital movement velocity ν is adjusted by altering the set-up of the entire satellite (2, 3) by changing the position of its center of mass.

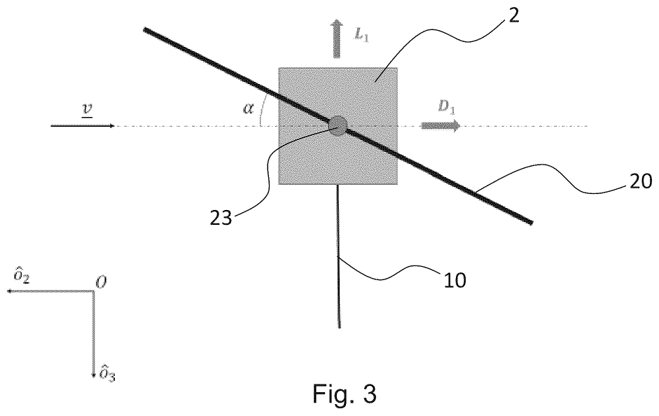

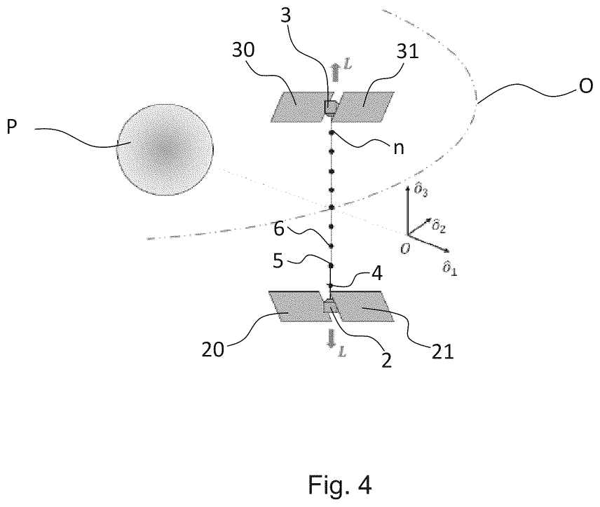

In the low orbit O, the panels 20, 21 and 30, 31 interact with the highest layers of the atmosphere and generate an aerodynamic force acting upon the orbital motion of the satellites 2 and 3, which can be broken up into a component D parallel to the tether 10 and a component L transversal to the tether 10, with reference to the notations in FIGS. 3 and 4.

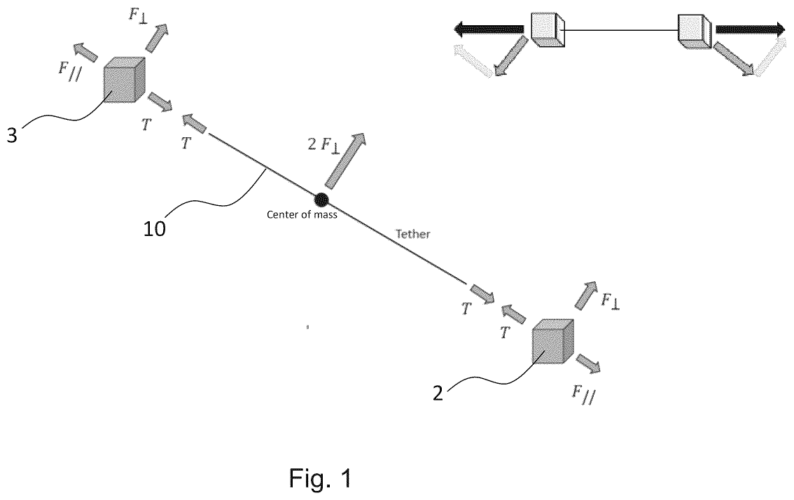

In the diagram of FIG. 1, which shows the forces involved, the perpendicular and transversal components of the forces generated by the panels' aerodynamic effect are designated as Fi and FI, while the tension of the tether 10 is designated as T.

By exploiting this effect of the panels 20, 21 and 30, 31, it is possible to develop techniques for stabilizing the formation of satellites 2, 3, 4, 5, 6, . . . n connected to the tether 10 in a generic configuration.

In order to do so, it is sufficient to generate mechanical tension in the tether 10 by applying forces onto the satellites 2, 3 connected to the ends of the tether 10.

The tension T in the tether 10 will be an internal resultant force of the system.

It is necessary that the stabilization forces generate an internal reaction force in the tether 10 in the desired direction: the latter will naturally tend to align in the direction of the resultant tension, thus maintaining the relative positions of the satellites in formation without requiring the use of active control strategies.

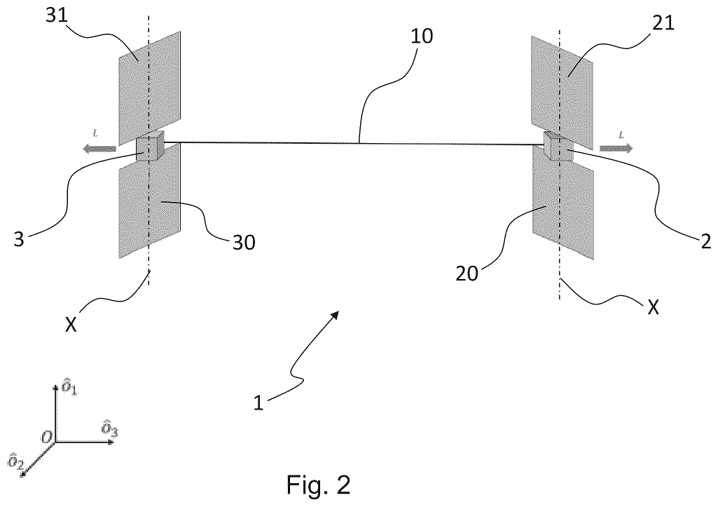

By generating an aerodynamic force in the system, the panels 20, 21 and 30, 31 will tighten the tether 10 and stabilize it in the desired direction. FIGS. 2 and 3 illustrate a case wherein aerodynamic lift (L) occurs in the transversal direction (designated as 63 in the reference system shown in FIG. 2), thus stabilizing the system in that direction. Of course, as shown in the side view of FIG. 3, the surfaces will also generate a resistance component (D) which, being similar for both satellites, will cause a rigid-body translation of the system, without affecting the relative position.

It must be pointed out that, in a state of equilibrium, the tension force T of the tether 10 coincides with the differential force acting upon the satellites 2, 3 connected to its ends (FIG. 1).

The other satellites 4, 5, 6 . . . n, arranged in intermediate positions along the tether 10, will follow its disposition, thus remaining aligned in the desired formation, which is not radial to the orbit O, but can be oriented in any way.

This feature of the invention represents an advantageous aspect, since it allows keeping a group of satellites in orbital flight formation by controlling just some of them, resulting in lower energy consumption and longer uptime and service life.

In other words, the method for satellite stabilization according to the invention only requires control over two satellites, i.e., satellites 2 and 3, which are located at the ends of the tether 10: this makes it possible to reduce the energy consumption necessary for such operation, so that, compared with prior-art satellite stabilization systems that generally act upon all satellites, the length of a mission can be increased.

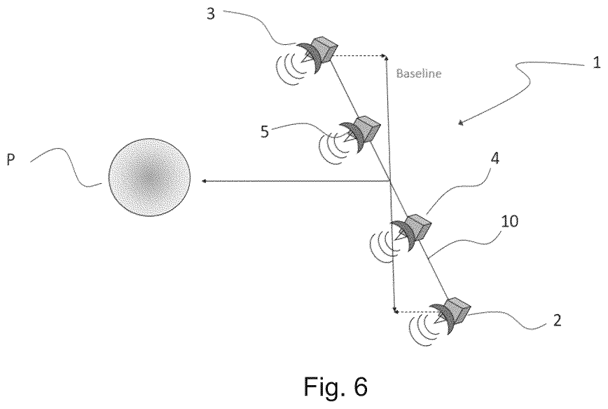

Furthermore, the state of the art includes some alternative solutions (Formation Flying) which provide a baseline which is constant over time (cf. FIG. 6); however, such systems suffer from a number of drawbacks.

As a matter of fact, such configurations require, the baseline being equal, a larger number of satellites than tethered systems because not all satellites contribute to observation at the same time. Since there is no mechanical constraint between the various satellites, any control action will require controlling all the members of the formation, resulting in increased overall system complexity. [Cf. Apa, R., Quadrelli, M. B., & Beauchamp, R. M. (2022, March): “Dynamics and Control of Helical Arrays in Low Earth Orbit”—In 2022 IEEE Aerospace Conference (AERO) (pp. 1-20). IEEE.]

This means that, in order to stabilize groups of satellites, according to the state of the art it is necessary to employ a complex control system for stabilizing and holding the relative positions of each individual satellite.

The solution proposed by the present invention makes the situation considerably simpler because, in fact, it is only necessary to control two, or anyway just a few, satellites for tensioning the tether, which is the element that effects the stabilization of the whole group of satellites.

Based on the same principle, a stable configuration of a tethered system can also be attained by introducing an external force to stretch the tether into the desired configuration, through the use of solutions alternative to the orientable surfaces of the example illustrated herein, or combinations thereof, in order to obtain the desired effect.

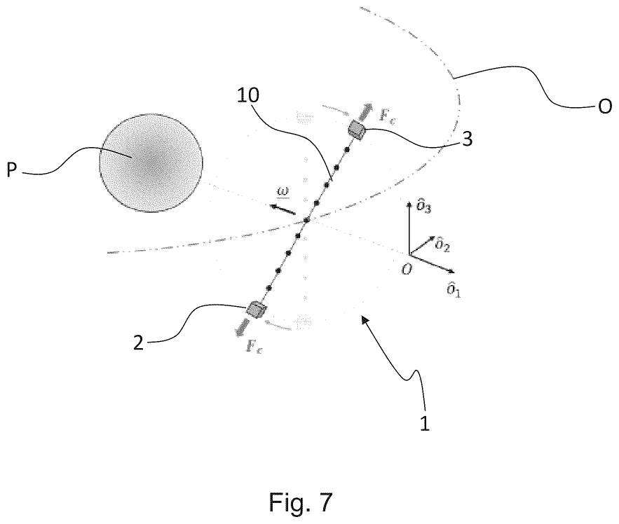

One possible alternative is shown in FIG. 7, wherein a group of satellites 2, 3, 4, . . . n are connected in the desired formation by the tether 10 and orbit around planet Earth P.

For simplicity, in the drawing the satellites 2 and 3 connected to the ends of the tether 10 lack the aerodynamic panels 20, 21, 30, 31; in this case, in order to obtain the desired tension T of the tether 10, the system is made to rotate @ about its center of mass.

This will generate a centrifugal force Fc that can be exploited to ensure the necessary tension along the tether 10 and achieve the same effect of stabilizing the formation in orbital flight as previously explained herein, resulting from the tension T applied to the tether.

This kind of stabilization, although it cannot guarantee a constant set-up of the whole system over time, may nevertheless be advantageous for some specific types of missions.

All the architectures proposed herein have high potential for remote radar sensing applications: by positioning several sensors along the tether 10, it is possible to emulate a large antenna, thanks to interference phenomena, by using MISAR (Motion Inducted Synthetic Aperture Radar) or Phased Array Beamforming techniques.

For such applications, it is of the utmost importance to extend the projection of the system along the direction perpendicular to the direction of observation (baseline).

It is nonetheless clear that the satellites 2, 3 connected to the ends of the tether 10 may also be equipped with directional panels 20, 21, 30, 31 in order to enhance the flight stabilizing action exerted on the group of satellites connected to the tether 10.

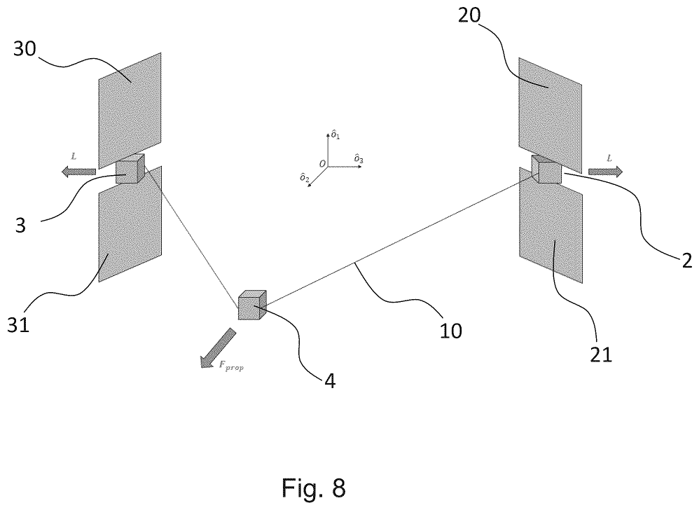

A further possible variant of the invention is shown in FIG. 8, which schematically illustrates a group of (three) satellites 2, 3 and 4 mutually connected by a tether 10.

The satellites 2, 3 at the ends of the tether 10 are equipped with orientable panels 20, 21, 30, 31, as already described above, while the central satellite 4 can be moved by electric propulsion, advantageously controllable by devices adapted for low orbit use.

As a matter of fact, since this variant is particularly intended for low-orbit applications, it permits the use of (in addition to the aerodynamic panels 20, 21, 30, 31) propulsors that utilize rarefied air to generate thrust, without requiring gaseous fuel storage aboard. This reduces the satellites' load and, unlike space satellites, makes the length of the mission independent of gaseous fuel stock.

Some examples of possible electric propulsors are those briefly designated as ABEP (Atmosphere-Breathing Electric Propulsion, or Air-Breathing Electric Propulsion—cf. Atmosphere-breathing electric propulsion—Wikipedia).

These propulsion systems have a special air intake collecting rarefied gas and directing it toward a thruster. Molecules are then ionized by the thruster and expelled from the acceleration stage at very high velocity, thereby generating thrust.

The electric power needed can be provided by power subsystems specially developed for electric power generation, like a combination of solar arrays and batteries, though other kinds of electric power subsystems may be considered as well.

The specifications of such motors may vary according to the mission's requirements, but they should preferably have a high specific impulse to ensure a constant thrust over time.

With this variant of the invention it is possible to combine the aerodynamic stabilization technique with a driving satellite 4 provided with electric propulsion, which compensates for the effects of aerodynamic resistance on the system.

This does not rule out that the driving satellite 4 could have, instead of ABEP propulsion systems, aerodynamic panels like those 20, 21, 30, 31 of the satellites 2, 3 connected to the ends of the tether 10.

All of the above-described features of the invention fall within the scope of the following claims.

1. A method for stabilization of the orbital motion set-up of a group of satellites bound to a tether, wherein the relative position of the satellites is maintained by applying a control tension (T) to the tether.

2. The method according to claim 1, wherein the control tension (T) of the tether is obtained, at least partly, by exerting a force on at least one satellite.

3. The method according to claim 2, wherein a satellite on which a force is exerted, is arranged at the end of the tether.

4. The method according to claim 1, wherein the motion of the satellites is in a low Earth orbit (O) and the control tension (T) of the tether is obtained by adjusting the disposition of one or more aerodynamic surfaces provided on the satellite whereon a force is exerted.

5. The method according to claim 4, wherein the aerodynamic surfaces are integral with the respective satellites, while the set-up of the associated satellite and/or the angle of incidence α relative to the orbital movement velocity ν of the aerodynamic surfaces are controlled by the position of the center of mass of the same satellite.

6. The method according to claim 1, wherein the control tension (T) of the tether is obtained, at least partly, by rotating at least one sub-group of satellites bound by the tether relative to the center of mass of the sub-group.

7. The method according to claim 1, wherein the control tension (T) of the tether is obtained, at least partly, by exerting a thrust on at least one driving satellite.

8. The method according to claim 7, wherein the driving satellite is in an intermediate position along the tether.

9. The method according to claim 7, wherein the thrust is obtained by means of ABEP electric propulsors.
